(19) United States
(12) Patent Application Publication
(10) Pub. No.: US 2009/0138399 A1
(43) Pub. Date: May 28, 2009

(54) PIN-LESS ATM PROCESSING SYSTEM

(75) Inventors: Peter Rae, San Diego, CA (US); Nancy Loomis, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/191,026

(22) Filed: Aug. 13, 2008

Related U.S. Application Data
(62) Division of application No. 11/536,536, filed on Sep. 28, 2006.

(51) Int. Cl. G06Q 40/00; G06Q 20/00

(52) U.S. Cl. 705/43; 705/35

(57) ABSTRACT

A system and method are provided for processing transactions across an ATM network without requiring the use of a PIN or a signature. The transactions can be aggregated to allow multiple purchases to be processed in a single transaction.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

Embodiments of the invention relate generally to a system for authenticating the identity of a consumer during an electronic transaction without requiring the use of a PIN or a signature from the consumer. Additional embodiments relate generally to conducting aggregated transactions.

### BACKGROUND

Several different types of electronic transaction systems exist today operating in a variety of different ways. For example, a traditional credit card system, utilizes an account identifier and a signature requirement for conducting in-person transactions between a physical merchant and a consumer. The merchant can compare the signature on the receipt with the signature on the signature stripe of the physical credit card. In addition when the credit card is used over a network, such as the Internet in a transaction between a consumer and an internet merchant, a CVV number on the back of the credit card can be used to confirm that the person making the transaction has access to the physical card. The financial risk is passed to the merchant in these situations to confirm that the user is who he or she claims to be.

In a credit card transaction, the merchant does not receive the funds immediately. Rather, the funds must be transferred from the card issuing bank or other financial institution that represents the consumer and the card acquiring bank or other financial institution that represents the merchant. In addition, a transaction can be challenged by a consumer if the consumer believes a charge to have been charged in error and a chargeback issued to credit the account of the consumer from the merchant's financial institution. Moreover, there is often a processing fee that is required for credit card transactions. In addition, in a typical credit card transaction, there is only a pre-authorization inquiry made to assess that the credit card can be used. There is no definitive assessment made that the funds are available. Thus, even when a consumer is authorized to use a credit card by way of a pre-authorization inquiry during a transaction, there is no guarantee that the consumer will later pay the credit card bill.

A different system is the signature debit card system. This system uses a debit account rather than a credit account. However, it does require a signature at a point of sale to confirm that the consumer is who he or she claims to be. Again, the signature can be compared to the signature on the back of the debit card to confirm the authentication. The debit card system is processed across a debit processing system. Furthermore, it makes an actual inquiry at the financial institution of the debit card holder to confirm that the funds are available. If the funds are available, they are debited at that time rather than at some later time. Thus, the merchant has an assurance that the funds are actually available and will be credited to the merchant. However, it is difficult to use such a system across a network such as the internet because of the signature requirement to assure the identity of the consumer.

A third system in use is the ATM PIN debit card system. This system utilizes a personal identification number (PIN) associated with the Primary Account Number (PAN) used on a debit card. When a user makes a transaction, the PIN is entered to confirm that the consumer is who he or she purports to be. The PIN is essentially a secret number. Thus, by entering the secret number, the merchant can have a third party—who also knows the PIN associated with the PAN—confirm that the consumer is who or she purports to be. This allows the consumer to conduct transactions at automated teller machines (ATMs) and with merchants located on a network such as the Internet. In addition, the ATM PIN debit card system can also be used in physical stores at point of sale devices. As a debit card system, a merchant is assured that the funds for the transaction will be transferred to the merchant.

A relatively new system is use of PIN-less debit for payment of bills. In such a system, the debit account can be used across a network such as the internet to pay bills. There is low risk of fraud because the billing account that is being paid identifies the user. Thus, there is low risk to the debit card system that someone will steal another's debit card to pay one's own utility bill. Thus, in this limited situation, the ATM network has been used to pay only bills. It has not apparently been used before in a signature-less and PIN-less manner to pay for consumer purchases. A PIN-less transaction is beneficial in that it does not require a user to enter or remember a PIN number associated with a debit account. Users typically easily remember passwords for their computer accounts; but, purely numeric passwords such as those used for debit cards can be difficult for some people to recall. Thus, it would be beneficial if a system could be configured to eliminate the need for a PIN number when conducting transactions across a network such as the Internet.

As was noted in the case of credit cards, a processing fee is often charged when a transaction takes place across a processing network. As a result, when an item of low value is being purchased, the processing charge can be significant relative to the cost of the good being purchased. Thus, for low value purchases, it can be cost prohibitive to use a processing network. This is harmful to not only the customer but also to the merchant and processing network. Thus, it would be beneficial if there were a way to be able to purchase low value items across a purchasing network and not have to incur the total processing fees associated with such purchases.

### SUMMARY

According to one embodiment of the invention, a method and system is provided to process financial transactions by receiving at the merchant a first transaction request from a user for a first goods purchase; storing the first transaction request at the merchant; receiving PAN information associated with an account from the user without receiving a PIN from the user for the PAN and without receiving a signature from the user for the PAN; storing the PAN information at the merchant; processing at the merchant a second transaction request from the user for a second goods purchase, the second transaction request separate from the first transaction request; and then utilizing the stored PAN information to process the first transaction request.

According to another embodiment of the invention, a method and system is provided to allow a user to transact a purchase across an ATM network, which comprises pre-registering a user with a merchant so as to provide the merchant with authenticating information; receiving at the merchant a transaction request from the user for a purchase of goods; authenticating the user by the merchant with the authenticating information; receiving PAN information associated with an account from the user without receiving a PIN from the user for the PAN and without receiving a signature from the user; processing the transaction by the merchant on the ATM network without the PIN and without the signature.

In accordance with another embodiment of the invention, a method and system are provided that comprises registering a merchant with an ATM processing network; requiring the merchant to register a prospective consumer with the merchant so as to enable the merchant to authenticate the prospective consumer during a transaction between the merchant and the prospective consumer without requiring the prospective consumer to submit a PIN associated with a PAN or to submit a signature associated with the PAN.

Another embodiment of the invention provides a method and system for processing transactions by utilizing a transaction amount field to indicate an amount of a transaction; utilizing an account identifier field to indicate an account of a financial institution from which payment is to be made; utilizing a PIN-less transaction type identifier field to identify the transaction as a PIN-less ATM purchase transaction; forwarding values for the transaction amount field, the account identifier field and the PIN-less transaction type identifier field across a network for use by a financial institution.

Further embodiments of the invention will be apparent to those of ordinary skill in the art from a consideration of the following description taken in conjunction with the accompanying drawings, wherein certain methods, apparatuses, and articles of manufacture for practicing the embodiments of the invention are illustrated. However, it is to be understood that the invention is not limited to the details disclosed but includes all such variations and modifications as fall within the spirit of the invention and the scope of the Claims.

### BRIEF DESCRIPTION OF THE DRAWINGS

FIG. 1 illustrates a flow chart demonstrating a method of conducting PIN-less transactions by a merchant in accordance with one embodiment of the invention.

FIG. 2A, 2B, and 2C illustrate a flow chart demonstrating a method of conducting PIN-less transactions by a merchant in accordance with one embodiment of the invention.

FIG. 3 illustrates a flow chart demonstrating a method of conducting PIN-less transactions by a processing network in accordance with one embodiment of the invention.

FIG. 4 illustrates a flow chart demonstrating a method of conducting PIN-less transactions by a processing network in accordance with one embodiment of the invention.

FIG. 5 illustrates a flow chart demonstrating a method of conducting payment transactions across a processing network in accordance with one embodiment of the invention.

FIG. 6 illustrates a flow chart demonstrating a method of conducting payment transactions across a processing network in accordance with one embodiment of the invention.

FIG. 7 illustrates a block diagram of a system that can be implemented to perform PIN-less ATM sales in accordance with one embodiment of the invention.

FIG. 8 illustrates a block diagram of a computer system that can be used to implement the system shown in FIG. 7 in accordance with one embodiment of the invention.

FIG. 9 illustrates a block diagram for implementing the computing devices such as those illustrated in FIG. 8.

FIG. 10 illustrates a data format for processing transactions, according to one embodiment of the invention.

### DETAILED DESCRIPTION

In the past, it has not been possible to conduct PIN-less purchase transactions across ATM PIN networks because there was no way for the merchant to confirm the identity of the consumer. In addition, most purchases are for large amounts so the risk of loss was too high to justify such a system. In accordance with at least one embodiment of the invention, however, a PIN-less transaction can now be accomplished across a network, such as the Internet, to allow purchases to take place. In accordance with yet another embodiment, a purchase for a small amount can be implemented to allow a user to purchase items that do not cost a large amount of money via an ATM network.

According to one embodiment of the invention, a system can be accomplished by a processing network by requiring a networked merchant, such as a merchant taking orders across the Internet, that participates on an ATM network to take commercially reasonable steps necessary to register a user. Thus, for example, the merchant would need to take steps to register users with the merchant's web site to assign the users with individual usernames and passwords. As part of that registration process, the merchant would need to take steps to authenticate the identity of the user before assigning the user a username and password. Similarly, the merchant would need to implement security measures to make sure that the username and password information could not be compromised so as to allow fraudulent transactions to take place. As noted above, the merchant would be required to take the commercially reasonable measures necessary to ensure that the registration processes are implemented.

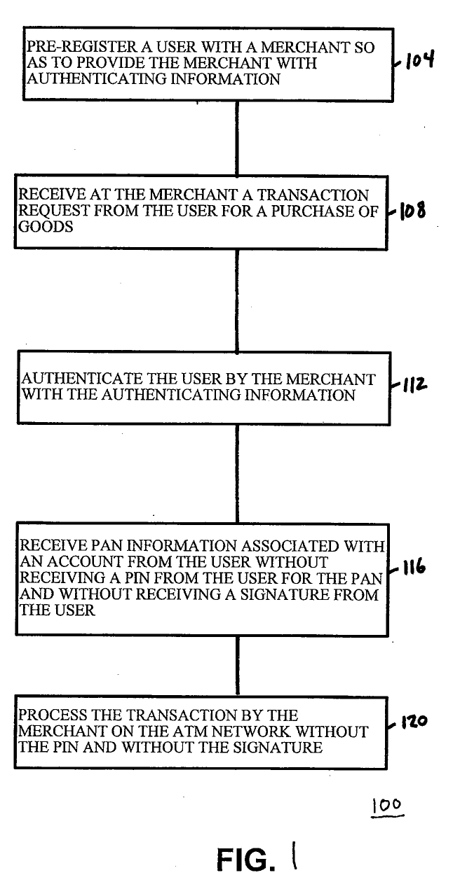

Referring now to FIG. 1, a flow chart 100 can be seen that illustrates one embodiment of the invention. In accordance with the flow chart shown in FIG. 1, a system can be implemented to conduct PIN-less purchase transactions across an ATM network. In block 104, a user is registered with a merchant prior to a purchase so as to provide the merchant with authenticating information. Such authenticating information is used by the user at a later time to allow the user to be authenticated by a web site of the merchant. Once the registration process is complete, a purchase transaction can be conducted. Thus, as shown by block 108, the merchant can receive a transaction request from the user for a purchase of goods. It should be understood for purposes of this patent that the term “goods” is intended to include services. In block 112, the user is authenticated by the merchant using authenticating information, such as a form of the authenticating information received during the registration process. Block 116 shows that the user can enter debit card information, such as the primary account number (PAN) associated with an account accessible via the ATM network. This information is received by the merchant without requiring the user to submit an impromptu signature or enter a PIN associated with the PAN. Finally, the merchant can process the transaction across the ATM network without the PIN and without the signature.

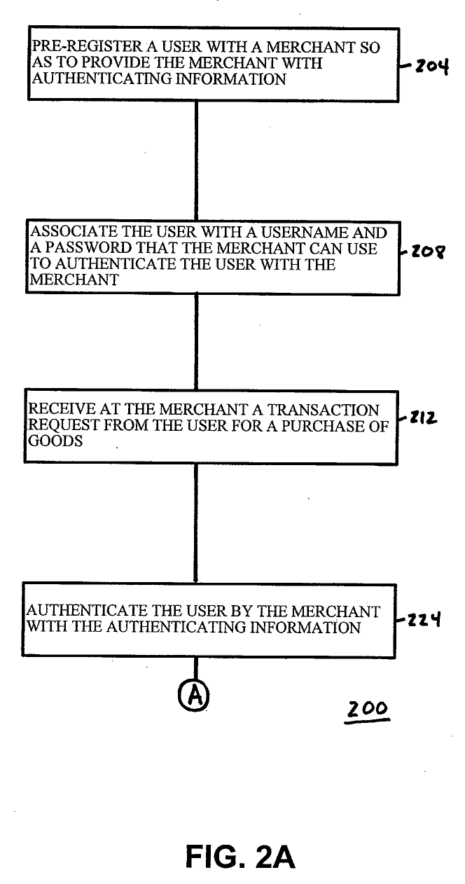

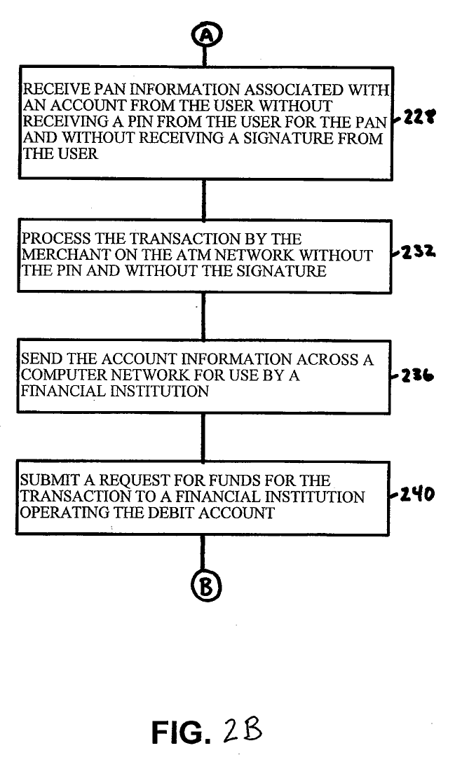

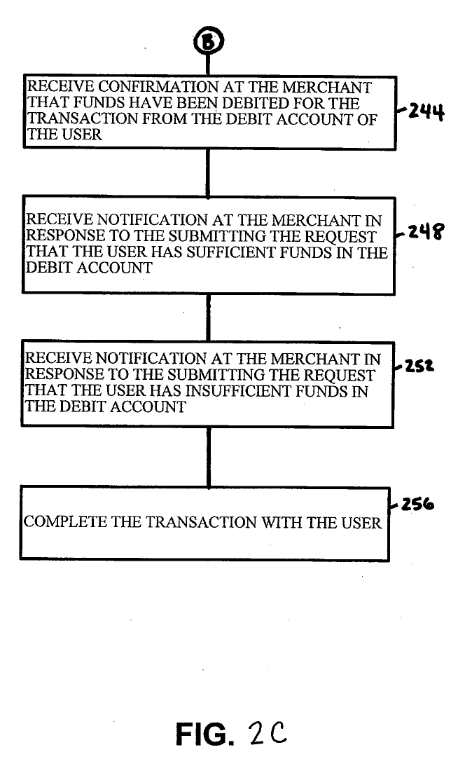

A more detailed example is illustrated by flow chart 200 of FIGS. 2A, 2B, and 2C. In block 204 of FIG. 2A, a user is registered with a merchant prior to the merchant and user entering into a transaction. The merchant provides the user with authenticating information, such as a username and password, so that the merchant can later authenticate the user during a purchase, as shown by block 208. In block 212, the merchant receives a transaction request from the user for a purchase of goods. And, in block 224, the merchant authenticates the user with the predetermined authentication information.

Thus, a consumer might register with a merchant's web site on Monday. As part of this registration process, the merchant would use commercially reasonable means to confirm that the user is who he or she purports to be. Thus, the merchant might rely on databases of known addresses for an applicant and compare a registration form for the consumer to see if the registrant correctly enters the prior places of residence. Similarly, the merchant might access credit bureau records and obtain data not easily obtained by the general public for use in confirming the identity of the registrant. In addition, the merchant might use the social security number to authenticate the individual. A variety of registration techniques could be used to authenticate the identity of the registrant as part of the registration process. The consumer might browse the web site the following Saturday. The consumer might then be required to submit the authenticating information to enter the web site or later be prompted for the authenticating information at the time of requesting a purchase. In either instance, the consumer would enter the authenticating information so as to be approved by the merchant. The merchant could perform the authentication by cross-referencing the entered authenticating information, such as username and password, and cross-referencing the information with a PAN number securely stored as part of the registration process for the consumer. The PAN number could then be accepted when the user enters it as part of the transaction.

Referring again to flow chart 200, block 228 illustrates that PAN information can be received that is associated with an account of a user. For example, debit cards typically have PAN numbers listed on them that are not actual account numbers. However, they are recognizable by the associated financial institution so that the associated financial institution that issued the debit card can determine which account the PAN applies to. Block 228 also illustrates that the PAN information is received without receiving a PIN from the user and without receiving a signature from the user. Thus, block 228 emphasizes that the transaction is both PIN-less and signature-less for purposes of authenticating the use of the PAN at the point of sale. Furthermore, it illustrates how the risk of fraud is placed squarely on the shoulders of the merchant to use its authentication process rather than relying on the processing network or financial institution to authenticate a user's PIN. In block 232, the transaction is processed by the merchant by submitting the transaction to the ATM system without the PIN and without any signature data. The account information (e.g., the PAN) is sent across the ATM network for use by the financial institution, as shown in block 236. For example, this can be implemented by submitting a request for funds for the transaction to the financial institution that operates the debit account, as shown by block 240. The financial institution reports back to the merchant across the processing system as to whether the debit account has sufficient funds. Such a determination involves an actual inquiry with the account at issue as opposed to a credit transaction where only a pre-authorization is performed. Thus, block 244 illustrates that the merchant receives confirmation that funds have been debited for the transaction from the debit account of the user. Alternatively, the merchant may receive notice that the user has sufficient funds in the debit account, as shown by block 248. Or, if sufficient funds are not available, block 252 illustrates that the merchant can receive notification that the user has insufficient funds in the debit account. Finally block 256 illustrates that the merchant completes the transaction with the user, such as by conveying the purchased goods to the user.

In accordance with another embodiment of the invention, the processing network can implement a system that is unique from previously employed processing systems. Such an embodiment is illustrated by FIG. 3. If flow chart 300 of FIG. 3, block 304 shows that a merchant is registered with an ATM processing network. To become an accepted merchant under the ATM processing network, the ATM processing network will also require that the merchant agree to register a prospective consumer with the merchant so as to enable the merchant to authenticate the prospective consumer during a transaction between the merchant and the prospective consumer. Furthermore, such authentication should be capable of being performed without requiring the prospective consumer to submit a PIN or signature associated with a PAN during a transaction.

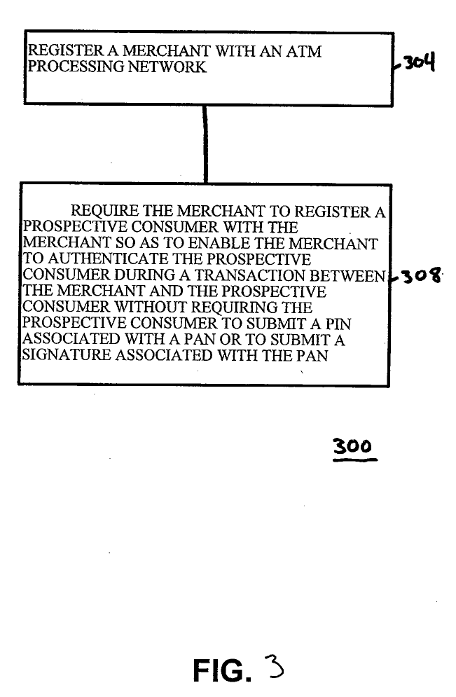

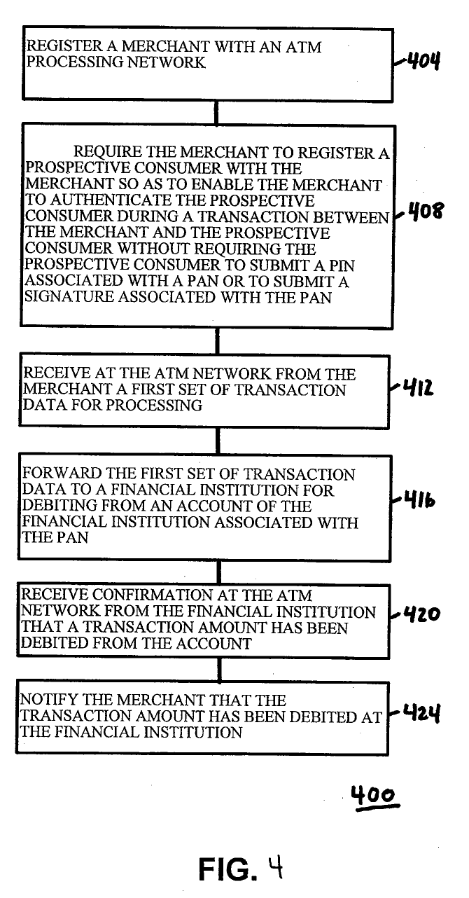

FIG. 4 illustrates a more detailed example of a processing network's actions in organizing a network for PIN-less purchases. In flow chart 400 of FIG. 4, a merchant is registered with an ATM processing network, as shown in block 404. The merchant is required to register a prospective consumer with the merchant so as to enable the merchant to authenticate the prospective consumer during a transaction between the consumer and the merchant. Furthermore, such authentication should be able to be accomplished without the use of a PIN associated with a PAN and without a signature associated with the PAN. In block 412, the ATM network receives from the merchant a first set of transaction data for processing. This first set of transaction data is forwarded to a financial institution for debiting from an account of the financial institution associated with the PAN, as shown in block 416. In block 420, the ATM network receives a confirmation message from the financial institution that a transaction amount has been debited from the account. The merchant can then be notified that the transaction amount has been debited at the financial institution.

Thus, the ATM processing network can be operated in such a way as to ensure that a merchant that wants to conduct PIN-less and signatureless transactions across the ATM network takes commercially reasonable steps to authenticate the consumer without requiring the consumer to use a PIN or a signature during an actual transaction. This can be beneficial for web sites that a consumer visits frequently for low cost digital content. Moreover, it can be useful for when a user subscribes to a subscription service that downloads digital content to the consumer at periodic or intermittent intervals. For example, when a consumer downloads music from a pay web site, the cost of each song can be a very low cost—such as under a $US 1.00. Similarly, when the user subscribes to a daily on-line newspaper, the cost for each edition can be very low cost—such as under $US 1.00. Thus, the risk of loss is somewhat low.

In addition, such purchases can be aggregated and processed as an aggregated transaction. An aggregated transaction in this instance takes the form of grouping multiple individual transactions and then processing the aggregated total across the ATM processing network as a single transaction. Aggregated transactions can be beneficial in that they do not incur multiple processing charges and do not require the resources of the network in multiple submissions across the network. U.S. patent application Ser. No. 11/147,581, filed on Jun. 7, 2005 and entitled “Dynamic Aggregation of Payment Transactions” describes in more detail examples of aggregated payment transactions and is hereby incorporated by reference for all purposes.

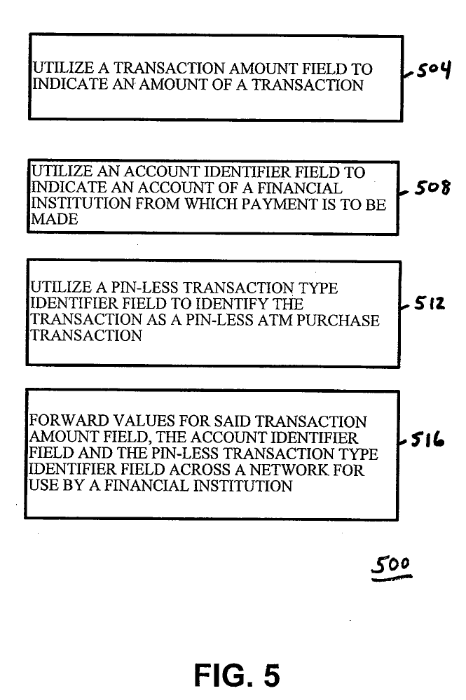

Referring now to FIG. 5 an embodiment of the invention can be seen for processing transactions across an ATM network, such as a PIN-less ATM network, by way of flow chart 500. In block 504 of flow chart 500, a transaction amount field is utilized to indicate an amount of a transaction. Block 508 shows that an account identifier field is used indicate an account of a financial institution from which payment is to be made. Block 512 utilizes a PIN-less transaction type identifier field to identify the transaction as a PIN-less ATM purchase transaction. Finally, block 516 shows that the values used for each of these fields can be forwarded across a network, such as the ATM network for use by the financial institution.

In addition, the transaction amount field can include a total amount for aggregated transactions. Thus, the total might comprise the amount for a first purchase and the amount for a subsequent and separate purchase. The merchant can hold the first purchase amount and thus process the amount of the first purchase with the second purchase.

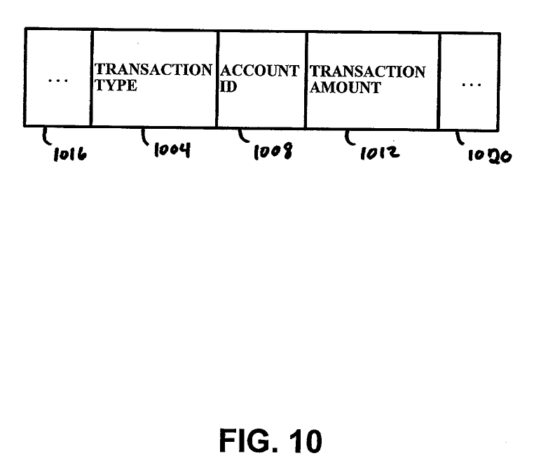

FIG. 10 illustrates a data structure for the fields used in the flow chart of FIG. 5. Namely, FIG. 10 illustrates a data structure that includes a transaction type field 1004, an account ID field 1008, and a transaction amount field 1012. These fields can be part of a larger message that includes a header portion 1016 and a footer portion 1020. Notably, the transaction type field can be used to indicate a type of PIN-less purchase transaction. For example, it might be used to distinguish the transaction from a PIN-less debit transaction. Or, it might also be used to indicate a particular type of PIN-less purchase transaction such as an aggregated transaction, a purchase of subscription information, a purchase of digital content, etc. It should also be noted that the account ID field can be used to pass the PAN information. Thus the account ID need not serve to specifically recite the account number at the financial institution. Rather, it can be used to point to the appropriate account at the financial institution, as would be understood by one of ordinary skill in the art.

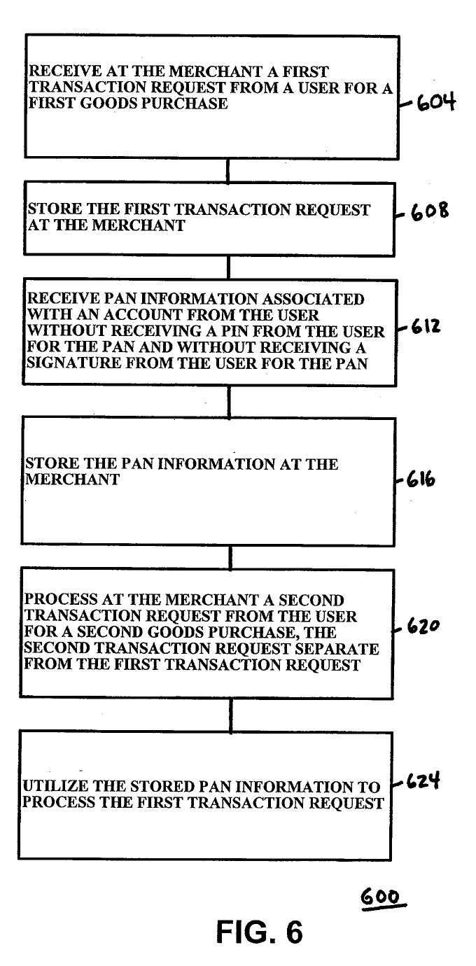

When aggregated transactions are used, the processing system can be configured to hold the PAN information and use it for processing at a later point in time. Thus, for example, a user could arrange with a merchant to purchase several digital downloads of music or subscribe to an on-line newspaper. The initial song could then be purchased from the merchant or the initial daily newspaper could be downloaded from the newspaper in order to initiate the process. Then, the merchant or newspaper could store the PAN information to use for subsequent purchases. Furthermore, the PAN information could be held and used after multiple purchases occurring at separate points in time wherein the purchase were then aggregated together after the latest occurring purchase. FIG. 6 illustrates one embodiment in accordance with flow chart 600. Namely, FIG. 6 shows in block 604 that a merchant receives a first transaction request from a user for a first goods purchase. Block 608 illustrates that the merchant stores the request at the merchant (including an agent of the merchant). As shown in block 612, the merchant can receive PAN information associated with an account from the user without receiving a PIN from the user and without receiving a signature from the user for the PAN. The PAN information can then be stored by the merchant as shown by block 616. In block 620, the merchant can process a second transaction request from the user that is separate from the first transaction request. This includes the situations where the consumer is purchasing a second song to download or when the consumer has previously arranged with a subscription service to have a periodic subscription downloaded (such as a daily newspaper).

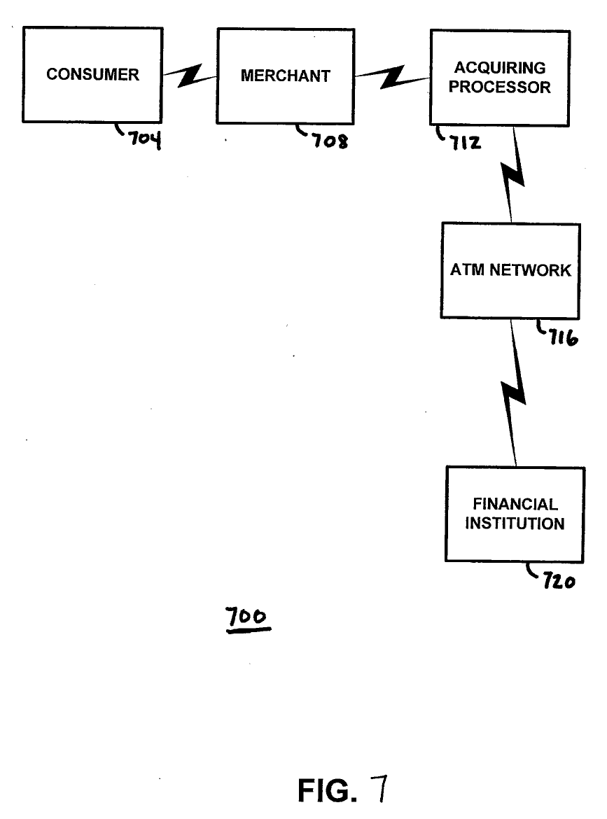

Referring now to FIG. 7, a block diagram of a processing system 700 is shown according to one embodiment of the invention. The processing system shows a consumer 704 in communication with a merchant 708, such as across a computer network such as what is commonly referred to as the Internet. The merchant as described above is a merchant that has arranged with the processing network to use commercially reasonable means to authenticate consumers during transactions. The merchant is also in communication with the processing network 716 which can be an ATM network that processes debit transactions. The merchant might communicate directly with the ATM network or indirectly via an acquiring processor 712 that serves the merchant. The ATM network can then communicate the transaction to the financial institution 720. The submission to the financial institution is also intended to encompass the situation where the submission is made to an issuing processor.

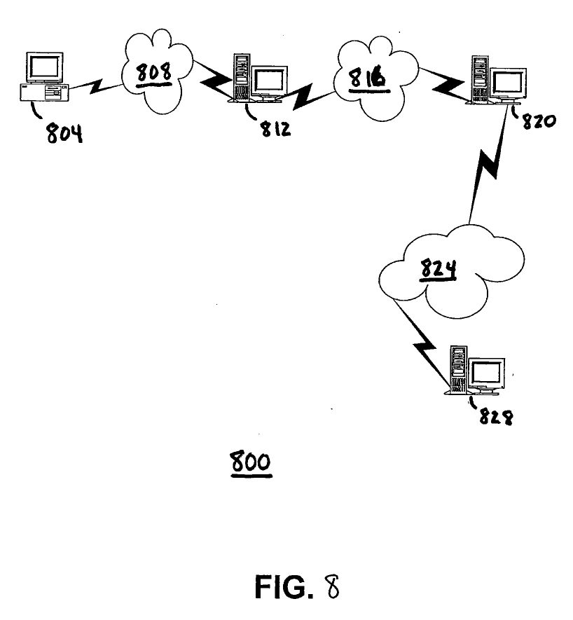

FIG. 8 illustrates a computer network that can be utilized to implement the system shown in FIG. 7. FIG. 8 shows a computer of a consumer 804 that is coupled to a computer network 808. Also coupled to that computer network 808 is a merchant computer 812. The merchant computer is coupled to a financial network 816 that allows the merchant to submit a transaction request to the acquirer processor computer system 820. The acquirer can submit the transaction to the ATM network 824 which is also coupled to the financial institution's computer system 828.

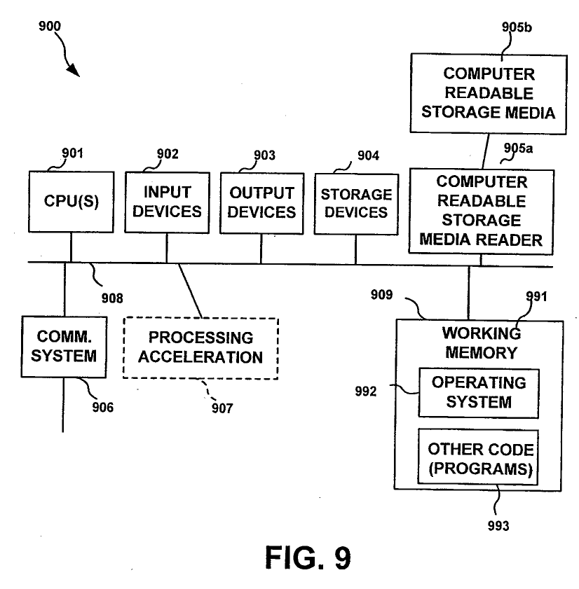

To implement the computer systems shown in FIG. 8, a device 900 such as that shown in FIG. 9 can be used. FIG. 9 broadly illustrates how individual system elements can be implemented. System 900 is shown comprised of hardware elements that are electrically coupled via bus 908, including a processor 901, input device 902, output device 903, storage device 904, computer-readable storage media reader 905a, communications system 906 processing acceleration (e.g., DSP or special-purpose processors) 907 and memory 909. Computer-readable storage media reader 905a is further coupled to computer-readable storage media 905b, the combination comprehensively representing remote, local, fixed and/or removable storage devices plus storage media, memory, etc. for temporarily and/or more permanently containing computer-readable information, which can include storage device 904, memory 909 and/or any other such accessible system 900 resource. System 900 also comprises software elements (shown as being currently located within working memory 991) including an operating system 992 and other code 993, such as programs, applets, data and the like.

System 900 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 900 component (e.g. within communications system 906). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Operating system utilization will also vary depending on the particular host devices and/or process types (e.g. computer, appliance, portable device, etc.) Not all system 400 components will necessarily be required in all cases.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well. Furthermore, the embodiments of the invention may be embodied as code stored in a computer-readable memory of virtually any kind including, without limitation, RAM, ROM, magnetic media, optical media, or magneto-optical media. Even more generally, the embodiments of the invention could be implemented in software, or in hardware, or any combination thereof including, but not limited to, software running on a general purpose processor, microcode, PLAs, or ASICs.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents, including the matter incorporated by reference.

It is thought that the apparatuses and methods of the embodiments of the present invention and its attendant advantages will be understood from this specification. While the above is a complete description of specific embodiments of the invention, the above description should not be taken as limiting the scope of the invention as defined by the Claims.

1.-5. (canceled)

6. A method of processing financial transactions via an ATM network, said method comprising:
registering a user with a merchant so as to provide said merchant with authenticating information;
receiving at said merchant a transaction request from said user for a purchase of goods;
authenticating said user by said merchant with said authenticating information;
receiving PAN information associated with an account from said user without receiving a PIN from said user for said PAN and without receiving a signature from said user;
processing said transaction by said merchant on said ATM network without said PIN and without said signature.

7. The method as claimed in claim 6 wherein said receiving said transaction request comprises receiving said transaction request comprised of at least two aggregated transactions.

8. The method as claimed in claim 7 wherein at least one of said aggregated transactions is for an amount less than $US 1.00.

9. The method as claimed in claim 6 wherein said processing said transaction comprises sending said account information across a computer network for use by a financial institution.

10. The method as claimed in claim 6 wherein said registering comprises:
associating said user with a username and a password that said merchant can use to authenticate said user with said merchant.

11. The method as claimed in claim 6 wherein said account is a debit account and further comprising:
receiving confirmation at said merchant that funds have been debited for said transaction from said debit account of said user; and then
completing said transaction with said user.

12. The method as claimed in claim 6 wherein said account is a debit account and wherein said processing by said merchant comprises:
submitting a request for funds for said transaction to a financial institution operating said debit account;
said method further comprising:
receiving notification at said merchant in response to said submitting said request that said user has sufficient funds in said debit account.

13. The method as claimed in claim 6 wherein said account is a debit account and wherein said processing by said merchant comprises:
submitting a request for funds for said transaction to a financial institution operating said debit account;
said method further comprising:
receiving notification at said merchant in response to said submitting said request that said user has insufficient funds in said debit account.

14.-21. (canceled)
